(19) United States
(12) Patent Application Publication
(10) Pub. No.: US 2014/0041500 A1
(43) Pub. Date: Feb. 13, 2014

(54) SLICED SPECIMEN PREPARING APPARATUS

(71) Applicants: Yoshihiko Isagawa, Neyagawa-shi (JP); Hideaki Hikawa, Neyagawa-shi (JP); Hiroaki Iida, Neyagawa-shi (JP); Yasushi Nakagawa, Neyagawa-shi (JP); Toshiyuki Murakami, Neyagawa-shi (JP)

(72) Inventors: Yoshihiko Isagawa, Neyagawa-shi (JP); Hideaki Hikawa, Neyagawa-shi (JP); Hiroaki Iida, Neyagawa-shi (JP); Yasushi Nakagawa, Neyagawa-shi (JP); Toshiyuki Murakami, Neyagawa-shi (JP)

(21) Appl. No.: 14/113,912

(22) PCT Filed: Apr. 25, 2012
(86) PCT No.: PCT/JP2012/061083

§ 371 Date: Oct. 25, 2013

(30) Foreign Application Priority Data
Apr. 26, 2011 (JP) 2011-098494

(51) Int. Cl. G01N 1/06

(52) U.S. Cl. CPC G01N 1/06
USPC 83/563

(57) ABSTRACT

To improve the freedom in material selection of cutter while suppressing increase in loads on the operator, a sliced specimen preparing apparatus of the present invention includes a cutter storage section storing a plurality of cutters, a specimen block cutting unit holding a cutter and slicing a surface layer of a specimen block, and a cutter transfer unit transferring a cutter stored in the cutter storage section to the specimen block cutting unit and replacing the cutter held by the specimen block cutting unit, the specimen block cutting unit is movable between a sliceable position where a blade edge of the cutter is oriented obliquely downward and a replacement position where the blade edge of the cutter is horizontally or oriented obliquely upward, and the cutter transfer unit replaces the cutter held by the specimen block cutting unit when the specimen block cutting unit is located at the replacement position.

### TECHNICAL FIELD

The present invention relates to a sliced specimen preparing apparatus for preparing a sliced specimen used for physical and chemical specimen analysis, microscopic observation of biological specimens, and the like.

### BACKGROUND ART

A microtome has been known as this type of apparatus conventionally. The microtome is a device that slices a specimen embedded in a paraffin or the like with a cutter to prepare a slice. The slice prepared by the microtome is stuck to a slide glass, and is used as a sliced specimen for the observation of tissues.

Conventionally, the work to prepare the sliced specimen by use of the microtome has been manually performed by the operator, and takes much time and lots of efforts. The required thickness of the sliced specimen is extremely small (which varies according to the specimen, and for example, is the range of 3 μm to 10 μm), and must be highly uniform. For this reason, even the skilled operator of the microtome generally takes a few days to process a few dozens of specimen blocks. Moreover, the similar operations are repeated many times, which puts excessive loads on the operator physically and mentally.

Thus, in recent years, various apparatuses that automate the work to prepare the sliced specimen to reduce loads on the operator have been proposed. Patent Document 1 (JP 2008-209303 A) discloses an apparatus configured to automatically replace a cutter for slicing the specimen block. When paraffin or the like is adhered to a blade edge of the cutter, the accuracy of the sliced specimen to be prepared next lowers. Since the apparatus disclosed in Patent Document 1 automatically replaces the cutter, the accuracy of the sliced specimen can be prevented from lowering without putting any load on the operator.

### PATENT DOCUMENT

Patent Document 1: JP 2008-209303 A

### SUMMARY OF THE INVENTION

### Problems to be Solved by the Invention

However, in the apparatus in Patent Document 1, the cutter whose blade edge is oriented obliquely downward is absorbed and held by a magnet provided along a cutter mounting surface of a cutter holder so as not to be slipped from the cutter holder due to gravity. For this reason, the cutter needs to be a magnetic material. That is, the apparatus in the Patent Document 1 has the problem that a material for the cutter is limited.

Further, in the apparatus in Patent Document 1, since the used cutter held by the cutter holder is pushed out by a new cutter to be replaced with the new cutter, the used cutter slides on the cutter mounting surface. At this time, the used cutter may be magnetized by the magnet. In this case, the magnetized used cutter cannot be separated from the cutter holder, or is adhered to other members, increasing loads on the operator.

Therefore, to solve the above-mentioned problems, the present invention provides a sliced specimen preparing apparatus that can improve the freedom in selection of a material for the cutter while suppressing an increase in loads on the operator.

### Means to Solve the Problems

In order to achieve the above object, the present invention is formed as follows.

According to a first aspect of the present invention, there is provided a sliced specimen preparing apparatus that slices a surface layer of a specimen block with a cutter to prepare a plurality of sliced specimens, the sliced specimen preparing apparatus comprising:

a cutter storage section which stores a plurality of cutters;

a specimen block cutting unit which holds the cutter and slices the surface layer of the specimen block; and

a cutter transfer unit which transfers a cutter stored in the cutter storage section to the specimen block cutting unit, thereby replacing the cutter held by the specimen block cutting unit, wherein

the specimen block cutting unit is movable between a sliceable position where a blade edge of the cutter is oriented obliquely downward and a replacement position where the blade edge of the cutter is horizontally or oriented obliquely upward, and

the cutter transfer unit replaces the cutter held by the specimen block cutting unit when the specimen block cutting unit is located at the replacement position.

According to a second aspect of the present invention, there is provided the sliced specimen preparing apparatus according to the first aspect, wherein the cutter transferred to the specimen block cutting unit pushes out the cutter held by the specimen block cutting unit, thereby the cutter transfer unit replaces the cutter held by the specimen block cutting unit.

According to a third aspect of the present invention, there is provided the sliced specimen preparing apparatus according to the first or second aspect, further comprising a controller which controls so that the specimen block cutting unit moves from the sliceable position to the replacement position each time the cutter held by the specimen block cutting unit slices the surface layer of the specimen block a preset number of times.

According to a fourth aspect of the present invention, there is provided the sliced specimen preparing apparatus according to the third aspect, wherein

after the specimen block cutting unit is moved to the replacement position, the controller controls so that the cutter transfer unit replaces the cutter held by the specimen block cutting unit, and

after the cutter held by the specimen block cutting unit is replaced, the controller controls so that the specimen block cutting unit moves from the replacement position to the sliceable position.

According to a fifth aspect of the present invention, there is provided the sliced specimen preparing apparatus according to the third aspect, wherein

the specimen block cutting unit is configured to be releasable of the hold of the cutter, and

the controller controls so that,

after the specimen block cutting unit is moved to the replacement position, the specimen block cutting unit releases the hold of the cutter,

in a state where the hold of the cutter is released, the cutter transfer unit replaces the cutter,

after the cutter held by the specimen block cutting unit is replaced, the specimen block cutting unit holds the replaced cutter, and

in a state where the replaced cutter is held, the specimen block cutting unit moves from the replacement position to the sliceable position.

### Effects of the Invention

In the sliced specimen preparing apparatus of the present invention, at the replacement position where the blade edge of the cutter is horizontally or oriented obliquely upward, the cutter held by the specimen block cutting unit is replaced and thus, the cutter can be prevented from slipping off at replacement due to gravity without using a magnet. Therefore, the freedom in selection of a material for the cutter can be improved, while suppressing an increase in loads on the operator.

### BRIEF DESCRIPTION OF THE DRAWINGS

The above and other objectives and features of the present invention will become apparent from the following description of preferred embodiments thereof with reference to the accompanying drawings, in which:

FIG. 1 is a block diagram showing a schematic configuration of a sliced specimen preparing apparatus in accordance with an embodiment of the present invention;

FIG. 2 is a schematic sectional view showing a configuration of a specimen block cutting unit;

FIG. 3 is a schematic sectional view showing a state where the specimen block cutting unit releases holding of a cutter; and

FIG. 4 is a schematic plan view showing constituents related to the specimen block cutting unit.

### MODE FOR CARRYING OUT THE INVENTION

Before describing the present invention, the same parts in the attached drawings are given the same reference symbols.

Hereinafter, embodiments of the present invention will be described with reference to the drawings.

### Embodiment

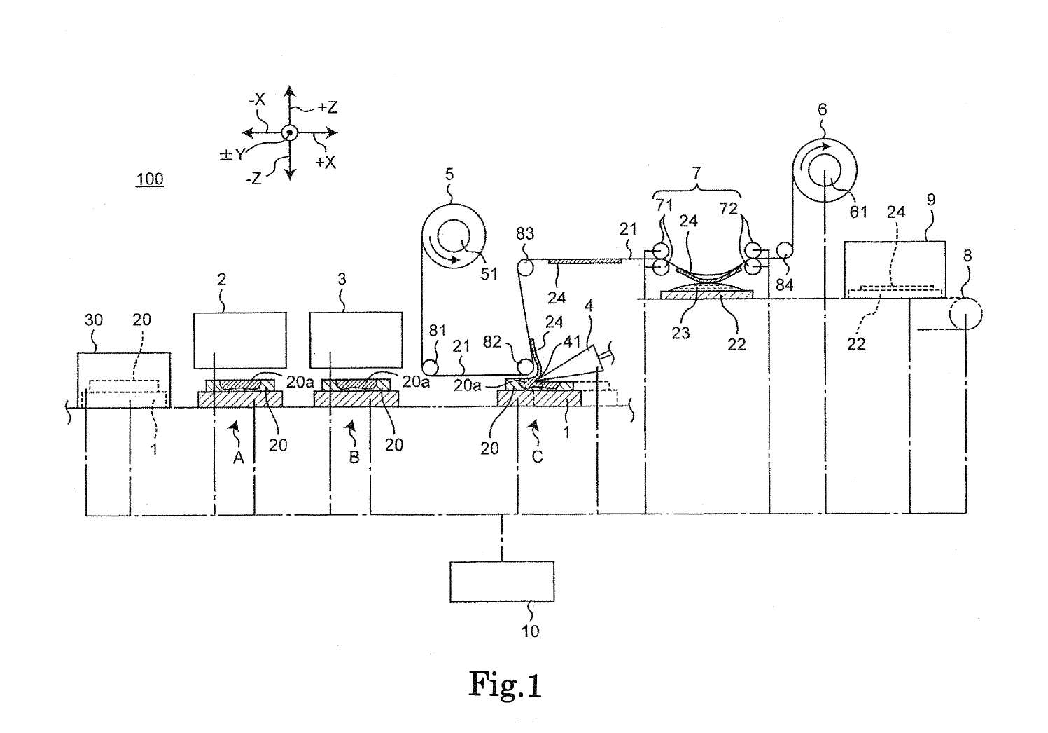

A schematic configuration of a sliced specimen preparing apparatus in accordance with an embodiment of the present invention will be described below. FIG. 1 is a block diagram showing the schematic configuration of the sliced specimen preparing apparatus in accordance with the embodiment of the present invention.

In FIG. 1, the sliced specimen preparing apparatus 100 is a device that slices the surface layer of a specimen block 20 with a cutter 41 automatically and continuously to prepare a plurality of sliced specimens 24. The specimen block 20 is formed by embedding a specimen 20a in an embedding material such as paraffin. Examples of the specimen 20a include biological specimens of human and animal tissues.

The sliced specimen preparing apparatus 100 includes a specimen block storage section 30 for storing the plurality of specimen blocks 20. One specimen block selected from the plurality of specimen blocks 20 stored in the specimen block storage section 30 is transferred to a specimen block cutting unit 4 including the cutter 41 by a specimen block transfer unit 1.

The specimen block transfer unit 1 is configured to take the specimen block 20 to be sliced next from the specimen block storage section 30, transfer the specimen block 20 to a position A and then allow the specimen block 20 to reciprocate between the position A to a position C. The positions A to C are linearly aligned in the horizontal direction (+/−X-axis direction). The specimen block transfer unit 1 is configured to adjust the height (+/−Z-axis direction) of the specimen block 20 such that the surface layer of the specimen block 20 can be sliced with the cutter 41.

A height detector 2 for detecting the height of the specimen block 20 is disposed above the position A. An imaging unit 3 for imaging a cut surface of the specimen block 20, which is sliced with the cutter 41 and exposed, is disposed above a position B. The imaging unit 3 is configured to have a part for irradiating the surface of the specimen block, such as a white light source or a monochrome LED light source, and an imaging part for acquiring image data, such as a CCD camera. The specimen block cutting unit 4 that can hold the cutter 41 and slice the surface layer of the specimen block 20 is disposed above the position C. The configuration of the specimen block cutting unit 4 will be described later in detail.

A carrier tape 21 for holding the sliced specimen 24 acquired by slicing the surface layer of the specimen block 20 with the cutter 41 is supplied above the position C. The carrier tape 21 is unreeled from a supply reel 5, and is supplied above the position C under guidance of guide rollers 81 and 82. The carrier tape 21 holding the sliced specimen 24 above the position C is wound around the take-up reel 6 under guidance of guide rollers 83 and 84.

The supply reel 5 is provided with a supply motor 51. By driving the supply motor 51, the carrier tape 21 is unreeled from the supply reel 5. The take-up reel 6 is provided with a take-up motor 61. By driving the take-up motor 61 at all times, a uniform torque is applied to the take-up reel 6 at all times. As a result, the carrier tape 21 unreeled from the supply reel 5 by driving the supply motor 51 is also wound around the take-up reel 6 at the same time.

The sliced specimen 24 held by the carrier tape 21 is stuck to the slide glass 22 by a slice sticking unit 7 disposed between the guide rollers 83 and 84. The slice sticking unit 7 includes a pair of guide rollers 71 disposed on the upstream side of a travelling path of the carrier tape 21 (on the side in the −X-axis direction) and a pair of guide rollers 72 disposed on the downstream side of the travelling path of the carrier tape 21 (on the side in the +X-axis direction). The slice sticking unit 7 sandwiches the carrier tape 21 between the pair of guide rollers 71 and 71 and the pair of guide rollers 72 and 72, and warps the carrier tape 21 downward to bring the sliced specimen 24 held by the carrier tape 21 into contact with the slide glass 22 to which an adhesive liquid 23 such as water is supplied. Thereby, the sliced specimen 24 is stuck to the slide glass 22. Hereinafter, the slide glass to which the sliced specimen 24 is stuck will be referred to as slide glass with slice.

A slide glass transfer unit 8 transfers the slide glass 22 with slice to the extension section 9. The slide glass transfer unit 8 transfers the slide glass 22 with slice to the extension section 9, takes the slide glass 22, to which the sliced specimen 24 is not stuck, from the slide glass storing section (not shown), and transfers the slide glass 22 below the slice sticking unit 7. The extension section 9 includes a heating plate (not shown), extends wrinkles on the sliced specimen 24, and completely evaporates moisture on the slide glass 22 to tightly fix the sliced specimen 24 to the slide glass 22.

Each of the constituents including the specimen block transfer unit 1 is controlled by a controller 10 in operation. The controller 10 controls the operation of each of the constituents on the basis of information inputted to an input section (not shown). The input section is configured to receive input of the number of the prepared slide glasses with slice, the number of sliced specimens to be stuck per slide glass, etc.

Next, the operation of preparing the sliced specimen 24 will be described. The operation of preparing the sliced specimen 24 is performed under control of the controller 10. Generally, in the state where the specimen block 20 is stored in the specimen block storage section 30, the specimen 20a is embedded in the embedding material so as not to be exposed to the outside (or so as to be slightly exposed). For this reason, in this embodiment, the surface layer of the specimen block 20 is roughly cut until the area of the exposed portion of the specimen 20a becomes a preset area and then, main cutting is performed to prepare the sliced specimen 24 having a thickness of about 3 μm to 10 μm. First, rough cutting will be described.

First, the specimen block transfer unit 1 takes the specimen block 20 to be sliced next from the specimen block storage section 30, and transfers the specimen block 20 to the position A.

Next, the height detector 2 detects the height of the specimen block 20.

Next, on the basis of the information detected by the height detector 2, the specimen block transfer unit 1 adjusts the height of the specimen block 20 such that the surface layer of the specimen block 20 becomes parallel to a direction in which the cutter 41 extends (+/−Y-axis direction) and a direction in which the specimen block 20 is transferred (+/−X-axis direction), and that the surface layer of the specimen block 20 is roughly cut with the cutter 41.

Next, the specimen block transfer unit 1 transfers the specimen block 20 to the position B.

Subsequently, the imaging unit 3 images the specimen block 20. Thereby, a maximum projected region (maximum projected area) of the specimen 20a in the specimen block 20 is recognized.

Subsequently, the specimen block transfer unit 1 transfers the specimen block 20 to the position C. Thereby, the surface layer of the specimen block 20 is roughly cut with the cutter 41.

Next, the specimen block transfer unit 1 transfers the specimen block 20 to the position B.

Subsequently, the imaging unit 3 images the cut surface of the specimen block 20 that is sliced with the cutter 41 and exposed.

When the area of the exposed portion of the specimen 20a on the cut surface of the specimen block 20 is less than a preset area (for example, 80% of the maximum projected region), the specimen block transfer unit 1 adjusts the height of the specimen block 20 such that the surface layer of the specimen block 20 is roughly cut with the cutter 41. After that, the specimen block transfer unit 1 transfers the specimen block 20 to the position C. Thereby, the surface layer of the specimen block 20 is roughly cut with the cutter 41 again. Then, the specimen block transfer unit 1 transfers the specimen block 20 to the position B, and the imaging unit 3 images the cut surface of the specimen block 20 again. The rough cutting of the specimen block 20 and imaging of the cut surface are repeated until the area of the exposed portion of the specimen 20a on the cut surface of the specimen block 20 is the preset area or more.

When the area of the exposed portion of the specimen 20a on the cut surface of the specimen block 20 is the preset area or more, rough cutting is finished, and main cutting is started. In the case where rough cutting and main cutting are different from each other in the cutter 41 or in the position of the blade edge 41a of the cutter 41, or in the case where the thickness of rough cutting is different from that of main cutting, to improve the accuracy of the thickness of the slice to be prepared, prior to the preparation of the sliced specimen 24 (prior to main cutting), it is preferable that, with the cutter 41 or at the position of the blade edge 41a of the cutter 41 in main cutting, only slicing with the thickness in main cutting is performed a few times, that is, a so-called throw-away cutting is performed.

In main cutting, the specimen block transfer unit 1 adjusts the height of the specimen block 20 such that the surface layer of the specimen block 20 is roughly cut with the cutter 41 (to have a thickness in the range of about 3 μm to 10 μm). After that, the specimen block transfer unit 1 transfers the specimen block 20 to the position C. Thereby, the surface layer of the specimen block 20 is sliced with the cutter 41 to prepare the sliced specimen 24. After that, the specimen block transfer unit 1 retracts the specimen block 20 from the position C to the position B or the like, and adjusts the height of the specimen block 20 such that the surface layer of the specimen block 20 is sliced with the cutter 41. The adjusting, slicing, and retracting operation of the height of the specimen block 20 is repeated automatically and continuously any number of times based on information inputted to the input section (not shown) to prepare any number of sliced specimens 24.

The sliced specimen 24 prepared by main cutting is stuck to the carrier tape 21. At this time, preferably, the surface of the carrier tape 21 is subjected to humidification, cooling, and charging such that the sliced specimen 24 is stuck to the carrier tape 21 more reliably. The sliced specimen 24 stuck to the carrier tape 21 is transferred to the slice sticking unit 7 by driving the supply motor 51 and the take-up motor 61, and is stuck to the slide glass 22 by the slice sticking unit 7. Then, the slide glass 22 with slice is transferred to the extension section 9 by the slide glass transfer unit 8. After that, the extension section 9 extends wrinkles on the sliced specimen 24, and tightly fixes the sliced specimen 24 to the slide glass 22.

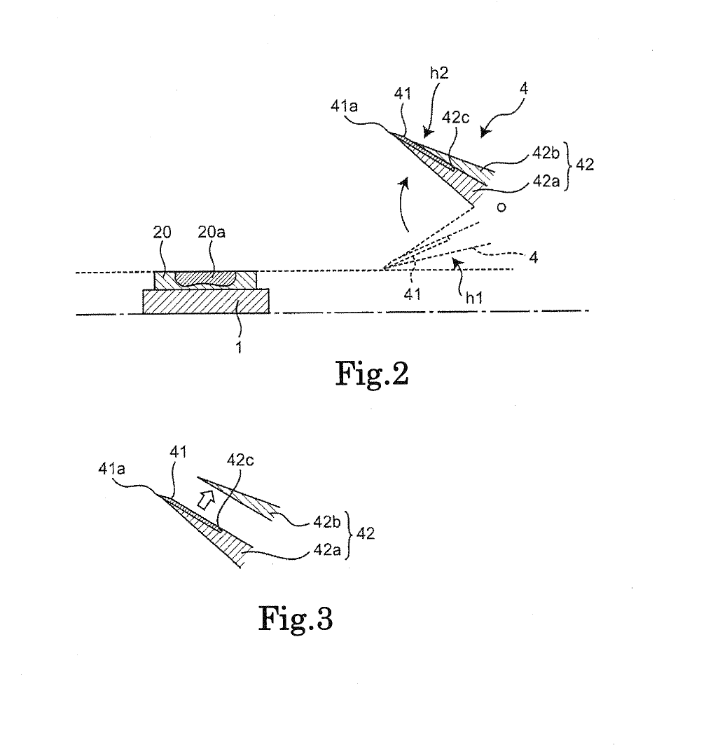

Next, the configuration of the specimen block cutting unit 4 will be described in more detail. FIG. 2 and FIG. 3 are schematic sectional views each showing the configuration of the specimen block cutting unit 4.

As shown in FIG. 2, the specimen block cutting unit 4 includes the cutter 41, and a cutter holder 42 for holding the cutter 41. The specimen block cutting unit 4 is configured to be movable between a sliceable position h1 where a blade edge 41a of the cutter 41 is oriented obliquely downward, and a replacement position h2 where the blade edge 41a of the cutter 41 is horizontally or oriented obliquely upward.

In slicing the surface layer of the specimen block 20, the specimen block cutting unit 4 is moved to the sliceable position h1 under control of the controller 10. When replacement of the cutter 41 is required, the specimen block cutting unit 4 is moved to the replacement position h2 under control of the controller 10. For example, the specimen block cutting unit 4 is moved from the sliceable position h1 to the replacement position h2 each time the cutter 41 held by the specimen block cutting unit 4 slices the surface layer of the specimen block 20 a preset number of times.

The cutter holder 42 includes a lower holding member 42a and an upper holding member 42b. As shown in FIG. 2, the lower holding member 42a and the upper holding member 42b are combined with each other to hold the cutter 41 therebetween. As shown in FIG. 3, the lower holding member 42a and the upper holding member 42b can be separated from each other so as to release the holding state of the cutter 41. The lower holding member 42a has a stepped section 42c for holding the cutter 41 such that the cutter does not slip off due to gravity. Although not shown, a blade positioning section is provided at the vicinity of each end of the cutter 41 such that the cutter 41 is reliably fitted into a space between the lower holding member 42a and the upper holding member 42b, that is, into a cutter holding position, and the blade positioning sections push the cutter 41 from the blade edge 41a of the cutter 41 toward the space so as not to contact the blade edge 41a of the cutter 41.

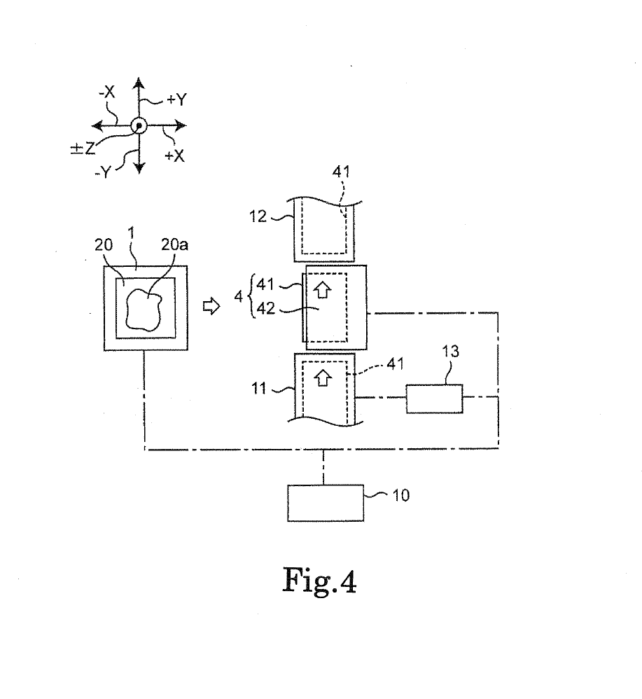

Next, constituents related to the specimen block cutting unit 4 will be described. FIG. 4 is a schematic plan view showing the constituents related to the specimen block cutting unit 4.

As shown in FIG. 4, a cutter storage section 11 and a cutter collecting section 12 are provided lateral to the specimen block cutting unit 4. The cutter storage section 11 stores a plurality of unused cutters 41. The cutter storage section 11 is connected to the cutter transfer unit 13 for transferring the cutter 41 stored in the cutter storage section 11 to the specimen block cutting unit 4 and replacing the cutter 41 held by the specimen block cutting unit 4.

When the specimen block cutting unit 4 is located at the replacement position h2, the cutter transfer unit 13 transfers the unused cutter 41 to the specimen block cutting unit 4 under control of the controller 10. Thereby, the unused cutter 41 pushes out the used cutter 41 held by the specimen block cutting unit 4 to replace the cutter 41 held by the specimen block cutting unit 4. The pushed used cutter 41 is collected by the cutter collecting section 12.

Next, the operation of replacing the cutter 41 held by the specimen block cutting unit 4 will be described in more detail. The operation of replacing the cutter 41 is performed under control of the controller 10.

First, when the cutter 41 held by the specimen block cutting unit 4 slices the surface layer of the specimen block 20 a preset number of times, the specimen block cutting unit 4 is moved from the sliceable position h1 to the replacement position h2.

Subsequently, the lower holding member 42a and the upper holding member 42b of the specimen block cutting unit 4 are separated from each other as shown in FIG. 3 to release the holding state of the cutter 41. At this time, the cutter 41 is held by a stepped section 42c of the lower holding member 42a so as not to slip off due to gravity.

Subsequently, the cutter transfer unit 13 transfers the unused cutter 41 from the cutter storage section 11 to the specimen block cutting unit 4, and the unused cutter 41 pushes out the used cutter 41 held by the specimen block cutting unit 4. Thereby, the cutter 41 held by the specimen block cutting unit 4 is replaced. The pushed used cutter 41 is collected by the cutter collecting section 12.

Subsequently, the blade positioning section pushes the cutter 41 from the blade edge 41a toward the stepped section 42c. After that, the lower holding member 42a and the upper holding member 42b of the specimen block cutting unit 4 are combined with each other as shown in FIG. 2 to hold the cutter 41 therebetween.

Next, the specimen block cutting unit 4 is moved from the replacement position h2 to the sliceable position h1. This completes the operation of replacing the cutter 41.

In this embodiment, since the cutter 41 held by the specimen block cutting unit 4 is replaced at the replacement position h2 in which the blade edge 41a of the cutter 41 is horizontally or oriented obliquely upward, the cutter 41 can be prevented from slipping off without using a magnet at replacement due to gravity. Therefore, the freedom in selection of a material for the cutter 41 can be improved while suppressing an increase in loads on the operator.

The present invention is not limited to the embodiment, and may be implemented in other various modes. For example, in this embodiment, the unused cutter 41 pushes out the used cutter 41 to replace the cutter 41 held by the specimen block cutting unit 4 and however, the present invention is not limited to this. For example, any member other than the unused cutter 41 may push out the used cutter 41 to replace the cutter 41 held by the specimen block cutting unit 4.

In this embodiment, the cutter holder 42 includes the lower holding member 42a and the upper holding member 42b however, the present invention is not limited to this. The cutter holder 42 only needs to hold the cutter 41.

In this embodiment, to facilitate sliding of the cutter 41, the holding state of the cutter 41 can be released and however, the present invention is not limited to this. For example, in the state where the specimen block cutting unit 4 holds the cutter 41, the unused cutter 41 may push out the used cutter 41 to replace the cutter 41 held by the specimen block cutting unit 4.

In this embodiment, the cutter collecting section 12 is provided and however, the cutter collecting section 12 is not necessarily provided.

Although the present invention has been fully described by way of preferred embodiments with reference to the accompanying drawings, it is to be noted that various changes and modifications will be apparent to those skilled in the art. Therefore, unless such changes and modifications otherwise depart from the scope of the present invention as recited in the attached claims, they should be construed as being included therein.

The entire disclosure of Japanese Patent Application No. 2011-098494 filed on Apr. 26, 2011, including specification, drawings, and claims is incorporated herein by reference in its entirety.

### INDUSTRIAL APPLICABILITY

Since the sliced specimen preparing apparatus of the present invention can improve the freedom in selection of a material for the cutter while suppressing an increase in loads on the operator, it is useful as a sliced specimen preparing apparatus used in physical and chemical specimen analysis, microscopic observation of biological specimens, and the like.

### EXPLANATION OF REFERENCE NUMERALS

1 specimen block transfer unit
2 height detector
3 imaging unit
4 specimen block cutting unit
5 supply reel
6 take-up reel
7s slice sticking unit
8 slide glass transfer unit
9 extension section
10 controller
11 cutter storage section
12 cutter collecting section
13 cutter transfer unit
20 specimen block
21 carrier tape
22 slide glass
23 adhesive liquid
24 sliced specimen
30 specimen block storage section
41 cutter
42 cutter holder
51 supply motor
61 take-up motor
71, 72, 81 to 84 guide roller
100 sliced specimen preparing apparatus

1-5. (canceled)

6. A sliced specimen preparing apparatus that slices a surface layer of a specimen block embedding a biological specimen with a cutter automatically and continuously to prepare a plurality of sliced specimens, the sliced specimen preparing apparatus comprising:
a cutter storage section which stores a plurality of cutters;
a specimen block cutting unit which holds the cutter and slices the surface layer of the specimen block;
a cutter transfer unit which transfers a cutter stored in the cutter storage section to the specimen block cutting unit so as to push out the cutter held by the specimen block cutting unit with the transferred cutter, thereby replacing the cutter held by the specimen block cutting unit;
a cutter collecting section which collects the cutter pushed out from the specimen block cutting unit; and
a controller controlling an operation of each of the specimen block cutting unit and the cutter transfer unit, wherein
the specimen block cutting unit is movable between a sliceable position where a blade edge of the cutter is oriented obliquely downward and a replacement position where the blade edge of the cutter is horizontally or oriented obliquely upward, and
the controller controls so that,
i) the specimen block cutting unit moves from the sliceable position to the replacement position each time the cutter held by the specimen block slices the surface layer of the specimen block a preset number of times,
ii) the cutter transfer unit replaces the cutter held by the specimen block cutting unit when the specimen block cutting unit is located at the replacement position, and
iii) after the cutter held by the specimen block cutting unit is replaced, the specimen block cutting unit moves from the replacement position to the sliceable position.

7. The sliced specimen preparing apparatus according to claim 6, wherein
the specimen block cutting unit is configured to be releasable of the hold of the cutter, and
the controller controls so that,
after the specimen block cutting unit is moved to the replacement position, the specimen block cutting unit releases the hold of the cutter,
in a state where the hold of the cutter is released, the cutter transfer unit replaces the cutter,
after the cutter held by the specimen block cutting unit is replaced, the specimen block cutting unit holds the replaced cutter, and
in a state where the replaced cutter is held, the specimen block cutting unit moves from the replacement position to the sliceable position.
